(19) United States
(12) Patent Application Publication
(10) Pub. No.: US 2026/0269994 A1
(43) Pub. Date: Sep. 10, 2026

(54) ALLOCATING ADDITIONAL PRBS TO SIDELINK COMMUNICATIONS IN ORDER TO MEET THE OCB THRESHOLD

(71) Applicant: QUALCOMM Incorporated, San Diego, CA (US)

(72) Inventors: Shaozhen GUO, Beijing (CN); Changlong XU, Beijing (CN); Siyi CHEN, Beijing (CN); Luanxia YANG, Beijing (CN); Jing SUN, San Diego, CA (US); Chih-Hao LIU, San Diego, CA (US); Xiaoxia ZHANG, San Diego, CA (US); Hao XU, Beijing (CN)

(21) Appl. No.: 19/162,892

(22) PCT Filed: Apr. 17, 2023
(86) PCT No.: PCT/CN2023/088609

§ 371 Date: Sep. 5, 2025

(51) Int. Cl. H04L 5/00; H04W 72/0457; H04W 72/25

(52) U.S. Cl. CPC H04L 5/0041; H04L 5/0094; H04W 72/0457; H04W 72/25

(57) ABSTRACT

Certain aspects of the present disclosure provide techniques for determining transport block sizes for sidelink communications. In one example, a method for wireless communications by a user equipment includes determining, based on an initial allocation of physical resource blocks (PRBs) in one or more sub-channels that are non-overlapping with a guard band within a resource pool for a sidelink communication, that an occupied channel bandwidth (OCB) threshold is not met for the sidelink communication; allocating one or more additional PRBs from the resource pool to the sidelink communication in order to meet the OCB threshold, wherein the one or more additional PRBs comprise at least one of: all partial sub-channel PRBs in a sub-channel of the resource pool partially overlapped by the guard band; or all boundary PRBs within the resource pool, but not allocated to a sub-channel of the resource pool.

### FIELD OF THE DISCLOSURE

Aspects of the present disclosure relate to wireless communications, and more particularly, to techniques for transport block size determination for sidelink communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes determining, based on an initial allocation of physical resource blocks (PRBs) in one or more sub-channels that are non-overlapping with a guard band within a resource pool for a sidelink communication, that an occupied channel bandwidth (OCB) threshold is not met for the sidelink communication; allocating one or more additional PRBs from the resource pool to the sidelink communication in order to meet the OCB threshold, wherein the one or more additional PRBs comprise at least one of: all partial sub-channel PRBs in a sub-channel of the resource pool partially overlapped by the guard band; or all boundary PRBs within the resource pool, but not allocated to a sub-channel of the resource pool.

Another aspect provides a method for wireless communications by a UE. The method includes receiving a sidelink communication using at least one of: all partial sub-channel PRBs in a sub-channel of the resource pool partially overlapped by a guard band; or all boundary PRBs within the resource pool, but not allocated to a sub-channel of the resource pool; determining a transport block size for the sidelink communication; and decoding the sidelink communication based on the transport block size.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more a processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example of a resource pool that may be used for sidelink communications.

FIG. 6 depicts a first example of how to determine the total number of allocated PRBs for a sidelink communication.

FIG. 7 depicts a second example of how to determine the total number of allocated PRBs for a sidelink communication.

FIG. 8 depicts a third example of how to determine the total number of allocated PRBs for a sidelink communication.

FIG. 9 depicts a fourth example of how to determine the total number of allocated PRBs for a sidelink communication.

FIG. 10 depicts a fifth example of how to determine the total number of allocated PRBs for a sidelink communication.

FIGS. 11A and 11B depict a sixth example of how to determine the total number of allocated PRBs for a sidelink communication.

FIG. 12 depicts a method for wireless communications.

FIG. 13 depicts another method for wireless communications.

FIG. 14 depicts aspects of an example communications device.

### DETAILED DESCRIPTION

Aspects of the present disclosure provide apparatuses, methods, processing systems, and computer-readable mediums for determining transport block size for sidelink communications.

A transport block is a block of data that is sent over an air interface from a transmitter side wireless communication device to a receiver side wireless communication device. In particular, a transport block may include a packet of data that is passed between a medium access control (MAC) layer and a physical (PHY) layer of a radio protocol stack. At a transmitter side wireless communication device, the packet of data may be passed downwards from the MAC layer to the PHY layer. At a receiver side wireless communication device, the packet of data may be passed upwards from the PHY layer to the MAC layer. For a receiver side wireless communication device to be able to decode a transport block received in a signal from the transmit side wireless communication device, the receiver side wireless communication device needs to determine a size of the transport block, also referred to as a transport block size (TBS).

Sidelink communications generally involve communication of transport blocks directly from a transmitter user equipment (UE) to a receiver UE (e.g., without a network intermediary) using resource pools having a number of sub-channels, which each include a configured number of physical resource blocks (PRBs) corresponding to time and frequency resources. The configured number of PRBs for a sub-channel within a resource pool may be referred to as the sub-channel size. A resource pool may further have one or more resource block sets comprising PRBs. In some cases, a resource pool may further include boundary PRBs that are not associated with a sub-channel, for example, when the sub-channel size does not divide equally into the number of PRBs within the resource pool. In some sidelink implementations, the smallest allocable unit for a sidelink communication is a sub-channel, and thus the TBS for the sidelink communication is generally a function of the number of sub-channels allocated to the sidelink communication and the number of PRBs associated with each allocated sub-channel, among other things.

When multiple sidelink communications are performed in contiguous resource blocks within a resource pool, a guard band is conventionally used to avoid interference between the sidelink communications. The guard band may be defined in such a way as to overlap one or more sub-channels. Because, as above, the smallest allocable unit for communication in sidelink is traditionally a sub-channel, a guard band overlapping a portion of a sub-channel may render all PRBs of that sub-channel unusable, including the PRBs in the non-overlapped portion of the sub-channel-since the non-overlapped PRBs cannot individually be allocated. This creates several technical problems. For example, wasting non-overlapped PRB resources in a sub-channel partially overlapped by a guard band decreases spectral utilization and increases latency. Further, wasting non-overlapped PRB resources may cause an occupied channel bandwidth (OCB) threshold (or requirement) for accessing the spectrum to not be met.

An OCB threshold generally refers to a portion of a frequency spectrum that should used by a wireless communication system when transmitting data, and may include bandwidth used for information signals as well as bandwidth required for modulation, filtering, and other signal processing functions. An OCB threshold may be established, for example, to ensure that a frequency spectrum is used efficiently and that different wireless systems can coexist without interfering with each other. OCB thresholds may be defined, in some cases, with respect to a nominal bandwidth of a given frequency band. For example, an OCB threshold may require that 80% of the nominal bandwidth of a given frequency band shall be used when accessing the frequency band, such as for sidelink transmissions and other unlicensed use. When an OCB requirement is not met for the allocated bandwidth, an intended sidelink communication may be prevented entirely.

Aspects described herein provide a technical solution to the aforementioned technical problems by exploiting PRBs in sub-channels that are partially overlapped by a guard band and/or PRBs within a resource pool that are not associated with a sub-channel (e.g., boundary PRBs). For example, according to aspects described herein, a UE may be configured to determine, based on an initial allocation of PRBs in one or more sub-channels that are non-overlapping with a guard band within a resource pool for a sidelink communication, that an OCB threshold is not met for the sidelink communication, and based on this determination, allocate one or more additional PRBs from the resource pool to the sidelink communication in order to meet the OCB threshold, wherein the one or more additional PRBs comprise at least one of: all partial sub-channel PRBs in a sub-channel of the resource pool partially overlapped by the guard band; or all boundary PRBs within the resource pool, but not allocated to a sub-channel of the resource pool. These aspects have the beneficial technical effects of improving spectral efficiency by utilizing more PRBs within a given resource pool, as well as reducing latency by transmitting more data in the given resource pool. In addition to these beneficial technical effects, UEs implementing the aspects described herein may overcome power spectral density (PSD) limitations by utilizing more bandwidth within a resource pool.

Conventional methods for determining TBS may not function properly when exploiting additional PRBs within a resource pool, such as in some aspects described herein. Further aspects described herein provide a technical solution to this technical problem by adapting TBS determination to account for using additional PRBs in a sidelink communication, such as PRBs in boundary PRBs not associated with a sub-channel. This creates a beneficial technical effect in that a transmitter UE can use more bandwidth and a receiver UE can still properly determine the TBS in order to successfully decode sidelink transmissions.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

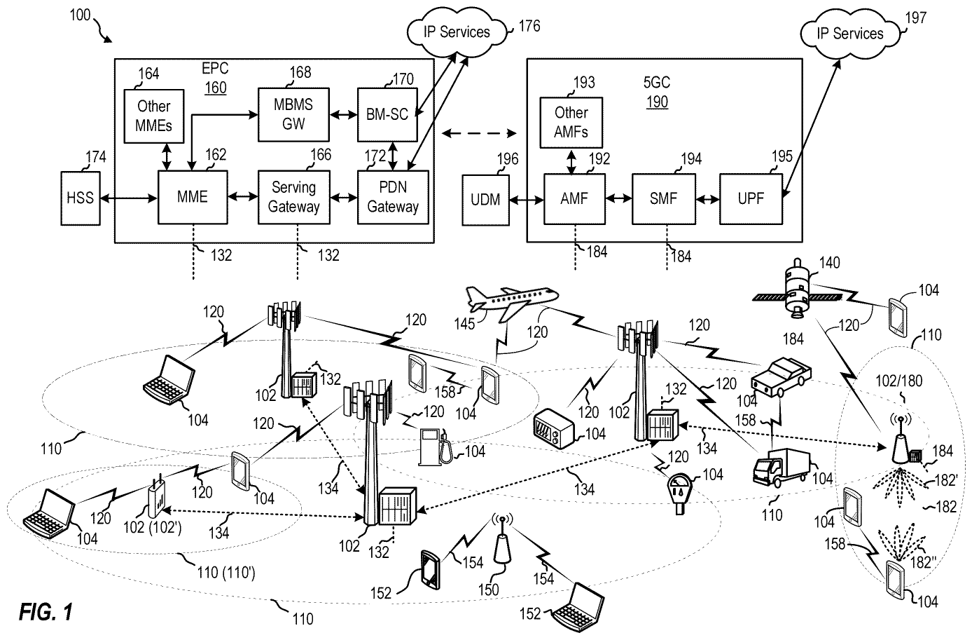

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

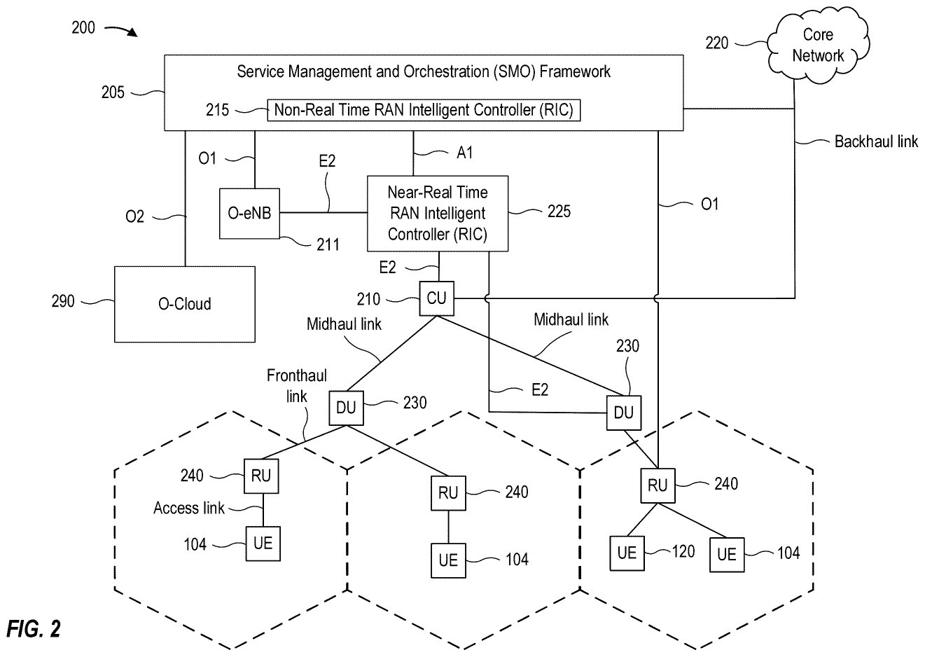

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

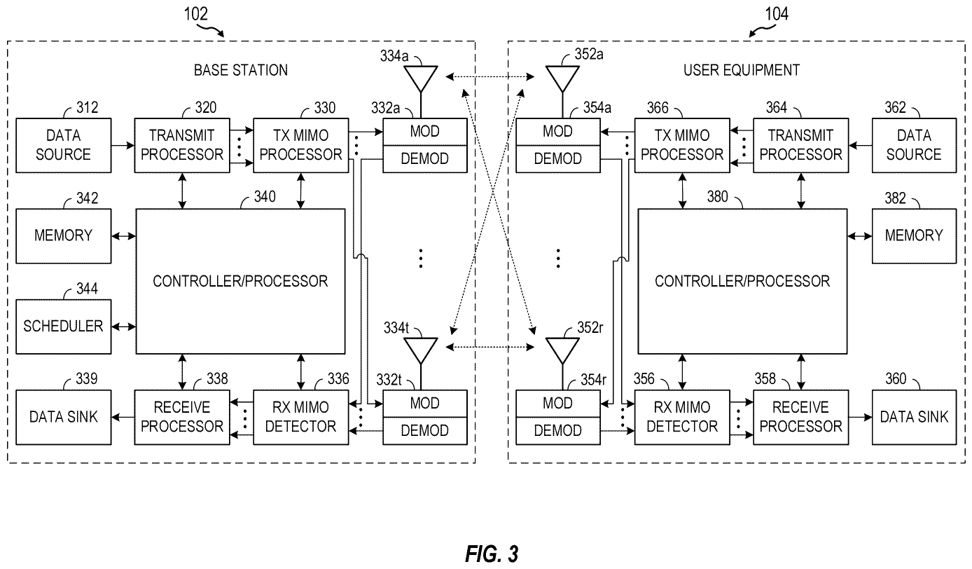

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

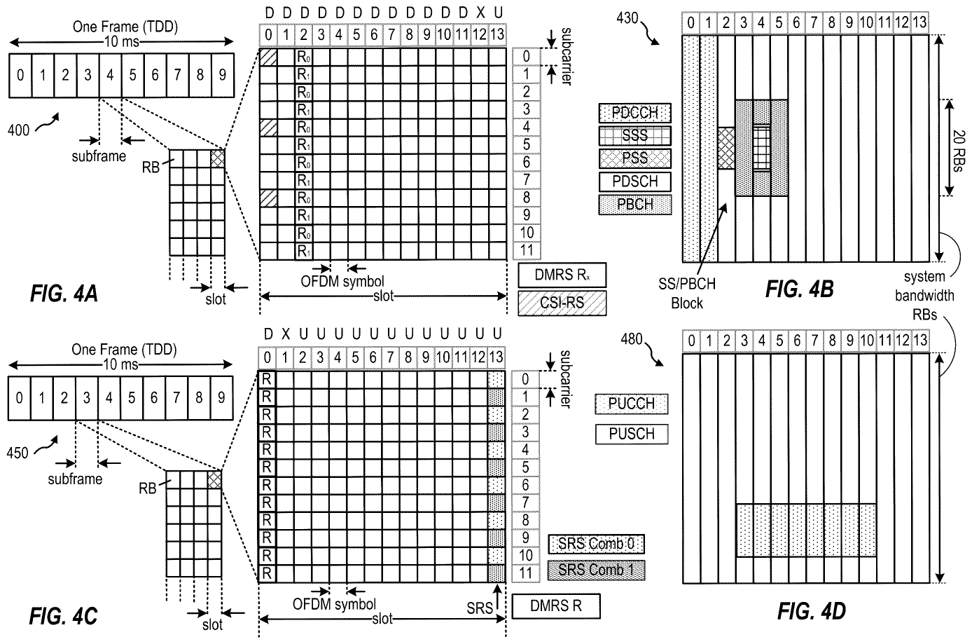

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Utilizing Unallocated Physical Resource Blocks for Sidelink Communications in Order to Meet Occupied Channel Bandwidth Thresholds

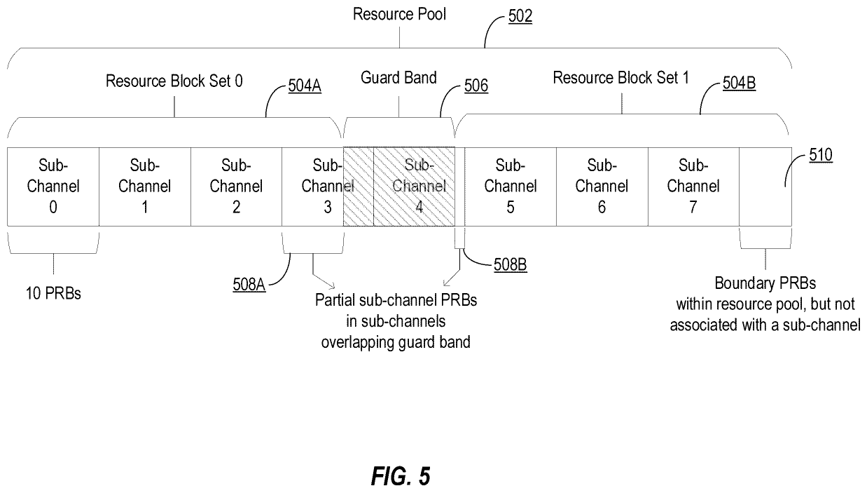

FIG. 5 depicts an example of a resource pool 502 that may be used for sidelink communications, such as between two UEs as described above with respect to FIGS. 1 and 3.

Resource pool 502 includes a first resource block set 504A and a second resource block set 504B separated by a guard band 506 (e.g., an intra-cell guard band). Resource pool 502 also includes eight sub-channels (indexed 0 through 7), which each comprise 10 physical resource blocks (PRBs) in this example. In other examples, different numbers of sub-channels and PRBs per sub-channel may be used.

In the example of FIG. 5, mapping of sub-channels starts from the first PRB of resource pool 502 and proceeds sequentially within resource pool 502 according to the sub-channel size (e.g., as may be defined by a number of PRBs within each sub-channel). Thus, the first sub-channel (sub-channel 0) aligns with a first boundary (leftmost) of resource pool 502. However, because the sub-channel size may not always divide evenly into the resource pool size, some PRBs within resource pool 502 may not be mapped to a sub-channel. For example, resource pool 502 includes “boundary PRBs” 510, which are not mapped to (associated with) a sub-channel.

When allocating sub-channels for a sidelink transmission, the minimum resource allocation granularity may be a sub-channel. Thus, if a sub-channel is allocated for the sidelink communication, all the PRBs in the sub-channel are likewise allocated to the sidelink communication. This means that when a sub-channel that overlaps with a guard band is allocated for a sidelink communication, so too are the PRBs within the guard band. Thus, conventionally, sub-channels overlapping a guard band are not used at all. While it is possible to perform PRB-level resource allocation, this may incur large signaling overhead

In the example of FIG. 5, guard band 506 separates first resource block set 504A and second resource block set 504B and overlaps portions of sub-channels 3 and 4. A guard band, such as 506, is generally a narrow frequency range used to separate two wider frequency ranges (e.g., first resource block set 504A and second resource block set 504B), which allows simultaneous transmission on the wider frequency ranges without co-interference. Notably, guard band 506 leaves some PRBs in partially overlapped sub-channels 3 and 4 technically available for data transmission since they are not within the guard band, but for the aforementioned resource allocation granularity. The PRBs that are technically available for data transmission within the sub-channels partially overlapped by guard band 506 are referred to as “partial sub-channel PRBs” 508A and 508B.

Notably, if partial sub-channel PRBs 508A and 508B and the boundary PRBs 510 are not used for data transmission, an occupied channel bandwidth (OCB) threshold (alternatively referred to as a bandwidth occupancy threshold) for resource pool 502 may not be met, and data transmission may be delayed. More generally, if the partial sub-channel PRBs 508A and 508B and the boundary PRBs 510 are not used-even if an OCB threshold is met-data transmission resources are nevertheless wasted, which reduces spectral efficiency and increases latency-both technical problems of conventional sidelink resource allocation approaches.

Accordingly, aspects described herein relate to exploiting partial sub-channel PRBs 508A and 508B and/or boundary PRBs 510 (collectively, “unallocated” or “unmapped” PRBs or “residual” PRBs) within resource pool 502. These aspects have the beneficial technical effects of improving spectral efficiency by utilizing more PRBs within a given resource pool, and reducing latency by transmitting more data in the given resource pool. Thus, aspects described herein provide a technical solution to the technical problem of meeting OCB thresholds while observing guard bands within resource pools.

Specifically, in some aspects described herein, a UE (e.g., a sidelink UE) may be configured to use boundary PRBs and/or partial sub-channel PRBs for sidelink communication (e.g., for sidelink transmissions and receptions) if an OCB threshold cannot be satisfied without using boundary PRBs and/or partial sub-channel PRBs.

In one aspect, boundary PRBs (e.g., 510) can be associated with an adjacent sub-channel (e.g., sub-channel 7 in FIG. 5) or treated as a standalone sub-channel for which the sub-channel size (e.g., in PRBs) is less than the nominal sub-channel size. For example, boundary PRBs 510 may be mapped to sub-channel 8 (not depicted) and include six PRBs, whereas the nominal sub-channel size is ten PRBs for sub-channels 0 through 7 in this example.

Considering the physical sidelink control channel (PSCCH) is transmitted in the lowest sub-channel of the sub-channels allocated to PSSCH, if the lowest sub-channel only includes partial sub-channel PRBs, the available PRBs that can be used for PSCCH may be smaller compared to a full sub-channel, which will degrade the PSCCH decoding performance. In addition, if the UE punctures the resource elements in the PRBs of the lowest sub-channel overlapping with the guard band, some of the control information may be lost, which will further degrade the PSCCH reliability. To reduce the impact to physical sidelink control channel (PSCCH) transmission when boundary PRBs and/or partial sub-channel PRBs are used for sidelink transmission, the boundary PRBs and/or partial sub-channel PRBs associated with larger (or higher) sub-channel indexes may be given higher priority than the boundary PRBs or partial sub-channel PRBs associated with smaller (or lower) sub-channel indexes. Generally then, unallocated or residual PRBs (e.g., boundary and/or partial sub-channel PRBs) may be allocated to a sidelink transmission in descending order of their associated sub-channel index until an OCB threshold is satisfied. This improves the chances that a starting sub-channel for a transmission is a full sub-channel (e.g., sub-channel 5) rather than a partial sub-channel (e.g., sub-channel 4).

An OCB threshold may generally be defined with respect to the allocated RB sets. For example, if only one RB set is allocated, e.g., RB set 0 is allocated, then the PSSCH has to occupy at least a threshold amount of resources (e.g., 80% of resources) in RB set 0. Similarly, if two RB sets are allocated, e.g., RB set 0 and 1, then the PSSCH has to occupy at least 80% of the resources in RB sets 0 and 1. Here, imagine the OCB threshold for resource block set 504B is 32 PRBs. A transmission mapped only to full sub-channels 5-7 would only have 30 PRBs-fewer than the threshold. According to aspects described herein, PRBs associated with the highest sub-channel index, here boundary PRBs 510, may be allocated to the transmission to meet the OCB threshold. Thus, in this example, two PRBs from boundary PRBs 510 may be allocated for the transmission so that the OCB threshold is satisfied.

Aspects Related to Determining Transmission Block Size when Utilizing Boundary and Partial Sub-Channel PRBs

When utilizing unallocated or residual PRBs, such as partial sub-channel PRBs and boundary PRBs, within a resource pool for sidelink communications, such as described above with respect to FIG. 5, the conventional method of determining transport block size (TBS) may be adapted to account for any additional PRBs.

Conventionally, to determine the TBS for a sidelink communication, a UE may first determine the number of resource elements (REs) within a slot and then determine the total number of REs allocated for physical sidelink shared channel (PSSCH). In one example, the UE determines the total number of REs allocated for PSSCH according to:

$${N}_{R E} = {N}_{R E}^{′} * {n}_{P R B} - {N}_{R E}^{SCI , 1} - {N}_{R E}^{SCI , 2} where {N}_{R E}^{′}$$

is the number of REs allocated for PSSCH within a PRB, n_{PRB} is the total number of allocated PRBs for the PSSCH,

$${N}_{R E}^{SCI , 1}$$

is the total number of REs occupied by the physical sidelink control channel (PSCCH) and PSCCH demodulation reference signals (DMRS), and

$${N}_{R E}^{SCI , 2}$$

is the number of coded modulation symbols generated for 2^{nd} stage SCI transmission (prior to duplication for the 2^{nd} layer), such as described in 3GPP TS 38.214 v17.2.0, section 8.1.3.2.

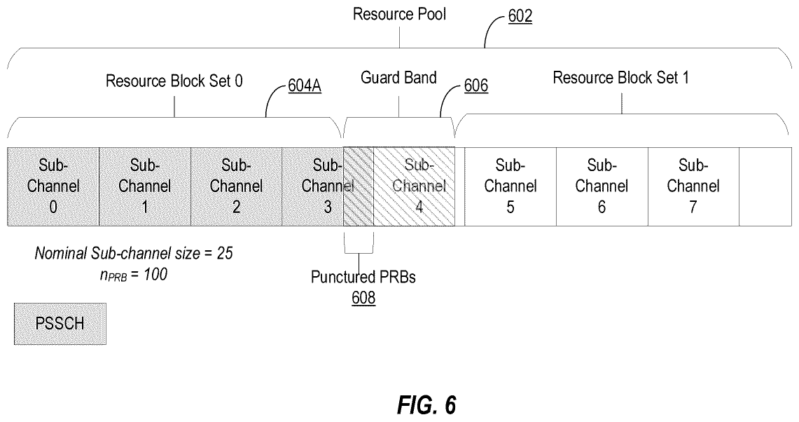

Aspects described herein determine the total number of allocated PRBs (n_{PRB}) according as described in more detail with respect to FIGS. 6-11B in order to account for the inclusion of unallocated or residual PRBs in a sidelink communication. The total number of allocated PRBs is then usable to determine a TBS for the sidelink communication.

FIG. 6 depicts a first example of how to determine the total number of allocated PRBs (n_{PRB}) for a sidelink communication in which a nominal sub-channel size is (pre)configured.

In this example, data for a sidelink transmission on the PSSCH are allocated to sub-channels 0-3 within resource block set 604A of resource pool 602, and sub-channel 3 overlaps the guard band 606. Since only RB set 0 604A is allocated to PSSCH, the PRBs of sub-channel 3 overlapping with guard band 606 may not be used for PSSCH. Only partial PRBs of subchannel 3 are used for PSSCH. Note, sub-channel 4 also overlaps guard band 606, but it is not allocated to the PSSCH transmission.

Here, n_{PRB} is determined based on a nominal sub-channel size, which may be pre-configured or signaled by a network entity or a peer UE (e.g., via PC5-RRC signaling). For example, here the nominal sub-channel size is 25 PRBs and therefore n_{PRB}=25×4=100.

For sub-channel 3, which overlaps guard band 606, the transmitting UE may perform rate-matching based on the full sub-channel size, including the PRBs overlapping with guard band 606, rather than based on only the PRBs not overlapping guard band 606. However, because in this example guard band 606 should not be used for transmission, the transmitting UE may puncture the transmission of the PRBs 608 overlapping with guard band 606. Puncturing, in this context, refers to reducing the redundancy of the transmitted data by removing the coded bits mapped to the REs of the PRBs 608 overlapping with guard band 606. Puncturing may be used along with error-correcting codes to add redundancy to the data while also selectively removing the punctured data. Thus, the overall amount of data that needs to be transmitted may be reduced while still maintaining a high level of error correction capability.

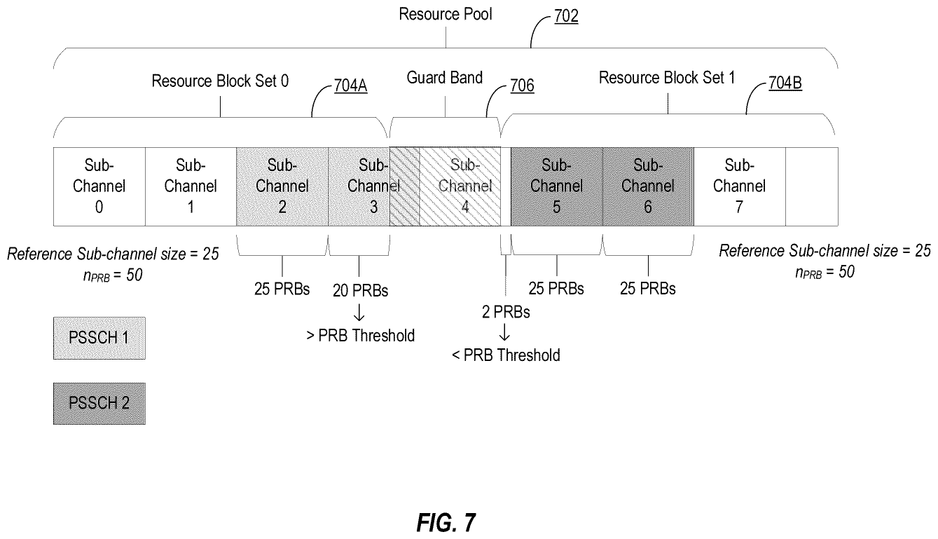

FIG. 7 depicts a second example of how to determine the total number of allocated PRBs (n_{PRB}) for a sidelink communication in which a reference sub-channel size is preconfigured for a resource pool.

In this example, data for a first sidelink transmission (PSSCH 1) are allocated to sub-channels 2 and 3 within resource block set 704A of resource pool 702. Since only RB set 0 704A is allocated to PSSCH 1, the PRBs of sub-channel 3 overlapping with guard band 706 may not be used for PSSCH 1. Only partial PRBs of subchannel 3 are used for PSSCH 1. In the second example, data for a second sidelink transmission (PSSCH 2) is allocated to sub-channels 5 and 6 within resource block set 704B of resource pool 702. Here, sub-channels 3 and 4 overlap the guard band 706.

Here, n_{PRB} may be determined based on a reference sub-channel size rather than a nominal sub-channel size as in the example of FIG. 6. In some aspects, the reference sub-channel size may be (pre) configured, e.g., per resource pool, such as resource pool 702. In some aspects, the reference sub-channel size for a resource pool can be reused or a new reference sub-channel size can be configured for the resource pool.

In this example, n_{PRB} is determined as the number of sub-channels allocated to the sidelink transmission (e.g., PSSCH or PSCCH) times the reference sub-channel size. For example, given a reference sub-channel size of 25 PRBs per sub-channel, for PSSCH 1 (occupying sub-channels 2 and 3) and PSSCH 2 (occupying sub-channels 5 and 6), n_{PRB}=25×2=50.

In some aspects, to avoid needing to increase the coding rate too significantly, a threshold can be (pre) configured so that the partial sub-channel PRBs can be used for PSSCH transmission only when the number of partial sub-channel PRBs is larger than the threshold. For example, sub-channel 3 has 20 partial sub-channel PRBs, which is greater than an example threshold of 15, whereas sub-channel 4 has only 2 partial sub-channel PRBs, which is less than the example threshold of 15. Accordingly, sub-channel 3 is allocated to PSSCH 1 while sub-channel 4 is not allocated to either PSSCH 1 or PSSCH 2.

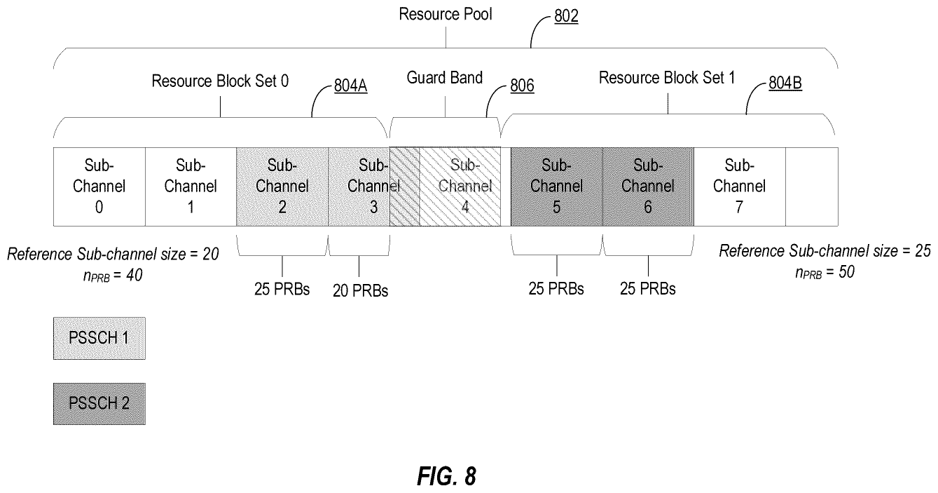

FIG. 8 depicts a third example of how to determine the total number of allocated PRBs (n_{PRB}) for a sidelink communication in which a reference sub-channel size is determined based on a minimum number of PRBs that do not overlap with a guard band among the multiple allocated sub-channels.

In this example, like the example of FIG. 7, data for a first sidelink transmission (PSSCH 1) are allocated to sub-channels 2 and 3 within resource block set 804A of resource pool 802. Since only RB set 0 804A is allocated to PSSCH 1, the PRBs of sub-channel 3 overlapping with guard band 806 may not be used for PSSCH 1. Only partial PRBs of subchannel 3 are used for PSSCH. In the second example, data for a second sidelink transmission (PSSCH 2) is allocated to sub-channels 5 and 6 within resource block set 804B of resource pool 802. Here, sub-channels 3 and 4 overlap the guard band 806.

Here, n_{PRB} is determined based on a reference sub-channel size that is based on a minimum number of PRBs that do not overlap with guard band 806 among the multiple allocated sub-channels. For example, for resource block set 804A, the minimum number of PRBs that do not overlap with guard band 806 is 20 in sub-channel 3, and thus the reference sub-channel size is 20 PRBs per sub-channel for PSSCH 1 (occupying sub-channels 2 and 3). Thus, for PSSCH 1, n_{PRB}=20×2=40, which is different than the example of FIG. 7 despite the same sub-channel allocation. For PSSCH 2 (occupying sub-channels 5 and 6), the minimum number of PRBs that do not overlap with guard band 806 is 25, thus n_{PRB}=25×2=50. Note, this configuration may result in a lower coding rate compared to the example of FIG. 7.

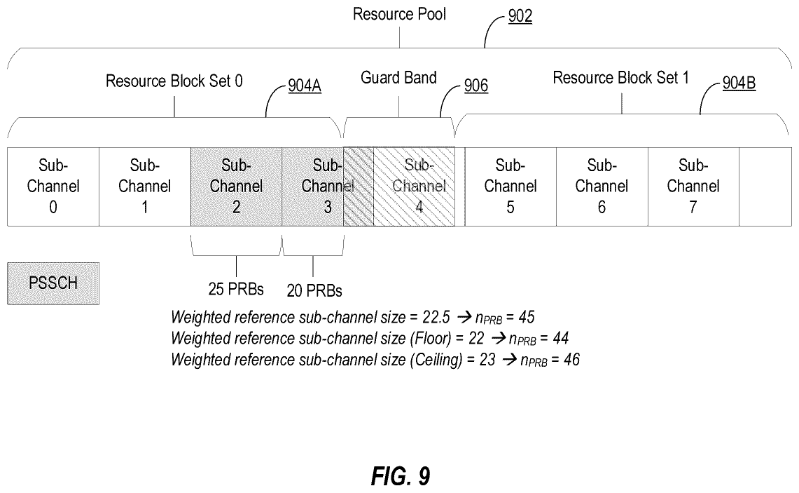

FIG. 9 depicts a fourth example of how to determine the total number of allocated PRBs (n_{PRB}) for a sidelink communication in which a reference sub-channel size is determined based on a weighted number of PRBs among the multiple allocated sub-channels.

In this example, data for a sidelink transmission (PSSCH) are allocated to sub-channels 2 and 3 within resource block set 904A of resource pool 902. Here, sub-channels 3 and 4 overlap the guard band 906. Since only RB set 0 904A is allocated to PSSCH, the PRBs of sub-channel 3 overlapping with guard band 906 may not be used for PSSCH. Only partial PRBs of subchannel 3 are used for PSSCH.

Here, n_{PRB} is determined based on a reference sub-channel size that is determined based on a weighted number of PRBs among the multiple allocated sub-channels.

For example, the weighted number of PRBs may be determined as:

$${w}_{1} * {N}_{1} * Subchannel size + {w}_{2} * {\sum }_{i = 1}^{{N}_{2}} {M}_{i} ,$$

$$floor ( {w}_{1} * {N}_{1} * Subchannel size + {w}_{2} * {\sum }_{i = 1}^{{N}_{2}} {M}_{i} ) , or$$

$$ceil ( {w}_{1} * {N}_{1} * size + {w}_{2} * {\sum }_{i = 1}^{{N}_{2}} {M}_{i} ) ,$$

where w₁ is the weight associated with sub-channels not overlapping with guard band 906, N₁ is the number of sub-channels not overlapping with guard band 906, w₂ is the weight associated with the sub-channels overlapping with guard band 906, N₂ is the number of sub-channels overlapping with the guard band 906, Mᵢ is the number of partial sub-channel PRBs of the i-th sub-channel that overlaps with guard band 906, floor is a function that takes as input a real number x, and gives as output the greatest integer less than or equal to x (sometimes indicated by └·┘), and ceil is a function maps x to the least integer greater than or equal to x (sometimes indicated by ┌·┐). In various aspects, w₁ and w₂ can be predefined or configured. For example, if average weighted number of PRBs are considered,

$${w}_{1} = {w}_{2} = \frac{1}{{N}_{1} + {N}_{2}} .$$

Thus, the total number of PRBs (n_{PRB}) may be determined as the number of sub-channels allocated to the sidelink communication (PSSCH in this example) times the reference sub-channel size, where the reference sub-channel size is based on weightings as above. For example, here let w₁=w₂=½, N₁=1 (referring to sub-channel 2), N₂=1 (referring to sub-channel 3), M₂=20, then

$${n}_{P R B} = 2 * ( \frac{1}{2} * 1 * 25 + \frac{1}{2} * 1 * 20 ) = 45 , or$$

$$2 * ⌊ \frac{1}{2} * 1 * 25 + \frac{1}{2} * 1 * 20 ⌋ = 44$$

if the floor function is used, or

$$2 * ⌈ \frac{1}{2} * 1 * 25 + \frac{1}{2} * 1 * 20 ⌉ = 46$$

if the ceil function is used.

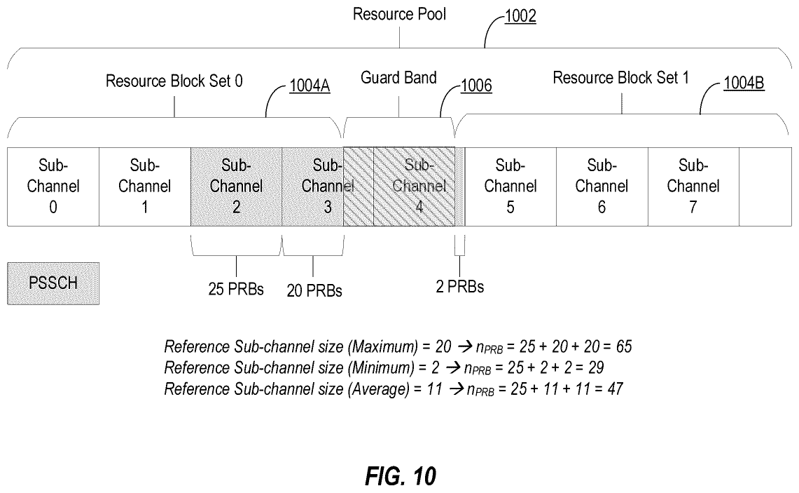

FIG. 10 depicts a fifth example of how to determine the total number of allocated PRBs (n_{PRB}) for a sidelink communication in which a reference sub-channel size is defined only for sub-channels overlapping with a guard band.

In this example, data for a sidelink transmission (PSSCH) are allocated to sub-channels 2 through 4 within resource block set 1004A and 1004B of resource pool 1002. Here, sub-channels 3 and 4 overlap the guard band 1006. Since both RB set 0 1004A and RB set 1 1004B are allocated to the PSSCH, the intra-cell guard band 1006 in between may be used for the PSSCH.

In this example, for sub-channels not overlapping with guard band 1006 (here, sub-channel 2), a (pre) configured sub-channel size associated with, for example, resource pool 1002, to determine n_{PRB}. For sub-channels overlapping with the guard band 1006 (here, sub-channels 3 and 4), a reference sub-channel size is determined based on, for example, the minimum, maximum, or average number of PRBs outside the guard band 1006 among the one or more sub-channels overlapping with guard band 1006.

Thus, here n_{PRB} may be determined as the number of allocated sub-channels not overlapping with guard band 1006 time the configured sub-channel size plus the number of allocated sub-channels overlapping with guard band 1006 times the reference sub-channel size (e.g., based on minimum, maximum, or average number of PRBs as above).

For example, here sub-channel 2, which does not overlap with guard band 1006, has a configured 25 PRBs. Sub-channel 3, which does overlap with guard band 1006, has 20 PRBs not overlapping guard band 1006. Sub-channel 4, which also overlaps with guard band 1006, has 2 PRBs not overlapping guard band 1006. So the reference sub-channel size based on: the minimum number of PRBs outside the guard band 1006 is two (associated with sub-channel 4); the maximum number of PRBs outside the guard band 1006 is twenty (associated with sub-channel 3); and the average number of PRBs outside the guard band 1006 is eleven (associated with sub-channels 3 and 4). Accordingly, n_{PRB} is 25+20+20=65 using the maximum metric, or 25+2+2=29 using the minimum metric, or 25+11+11=47 using the average metric.

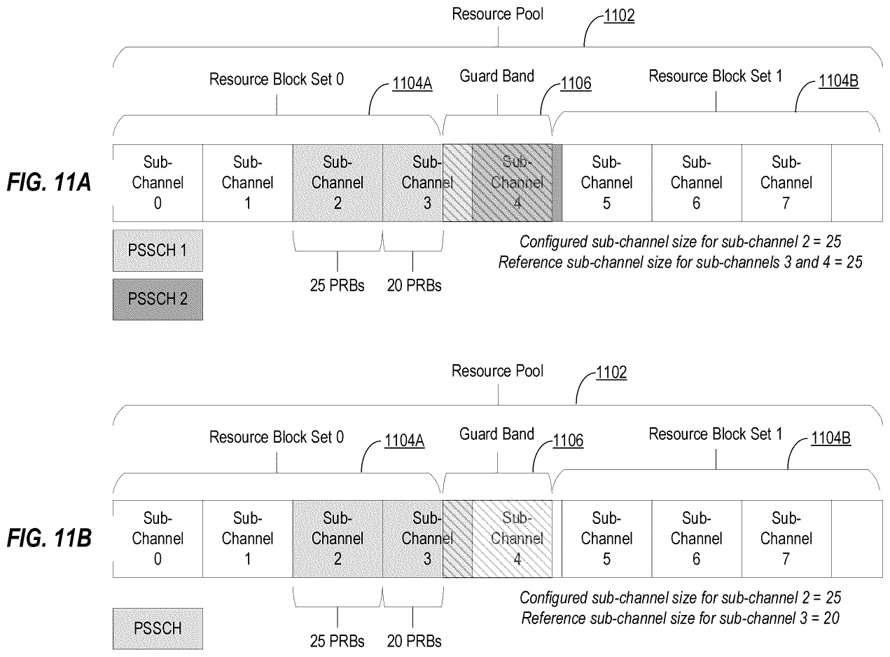

FIGS. 11A and 11B depict a sixth example of how to determine the total number of allocated PRBs (n_{PRB}) for a sidelink communication in which a reference sub-channel size is dynamically indicated by a transmitting UE.

In FIG. 11A, data for sidelink transmissions (PSSCH 1 and PSSCH 2) from the same transmitting UE are allocated to sub-channels 2 through 4 within resource block set 1104A and 1104B of resource pool 1102, where PSSCH is allocated to subchannel 1 and 3, PSSCH 2 is allocated to subchannel 4. Here, sub-channels 3 and 4 overlap the guard band 1106. Since both RB set 1004A and 1004B are allocated to transmission from a same UE 104, the guard band 1106 may be used. For PSSCH 1, the PRBs overlapping with guard band 1106 in subchannel 3 may be used. For PSSCH 2, the PRBs overlapping with guard band 1106 in subchannel 4 may be used.

In this example, the transmitting UE indicates whether a partial sub-channel size or full sub-channel size is used as the reference sub-channel size for the sub-channels that overlap with guard band 1106. Notably, when PSSCH 1 and PSSCH 2 are sent by the same transmitting UE, there is no issue of interference between PSSCH 1 and PSSCH 2, thus all PRBs, including those that overlap guard band 1106, may be used. In other words, the transmitting UE may indicate that a full sub-channel size is used as the reference sub-channel size even for the sub-channels that overlap with guard band 1106.

Thus, in the example of FIG. 11A, where PSSCH 1 and PSSCH 2 are sent by the same transmitting UE, the transmitting UE may indicate a full sub-channel is used for sub-channel 3 and 4, respectively, and thus a reference sub-channel size of 25 is used for sub-channel 3 and 4, and n_{PRB} may be determined as the number of allocated sub-channels not overlapping with guard band 1106 times the configured sub-channel size+the number of allocated sub-channels overlapping with guard band 1106 times the indicated reference sub-channel size. In this case, the number of allocated PRBs corresponding to PSSCH 1 is n_{RPB1}=(1×25)+(1×25)=50 and the number of allocated PRBs corresponding to PSSCH 2 is n_{RPB2}=1×25=25.

In the example of FIG. 11B, where the transmitting UE is only sending PSSCH in sub-channels 2 and 3, since only RB set 1104A is allocated to PSSCH, the PRBs overlapping with guard band 1106 in subchannel 3 may not be use and the transmitting UE may indicate a partial sub-channel is used for sub-channel 3. Thus a reference sub-channel size of 20 (e.g., a partial sub-channel size) is considered for sub-channel 3 and n_{PRB} may be determined as (1×25)+(1×20)=45 in this case.

### Example Operations by a User Equipment

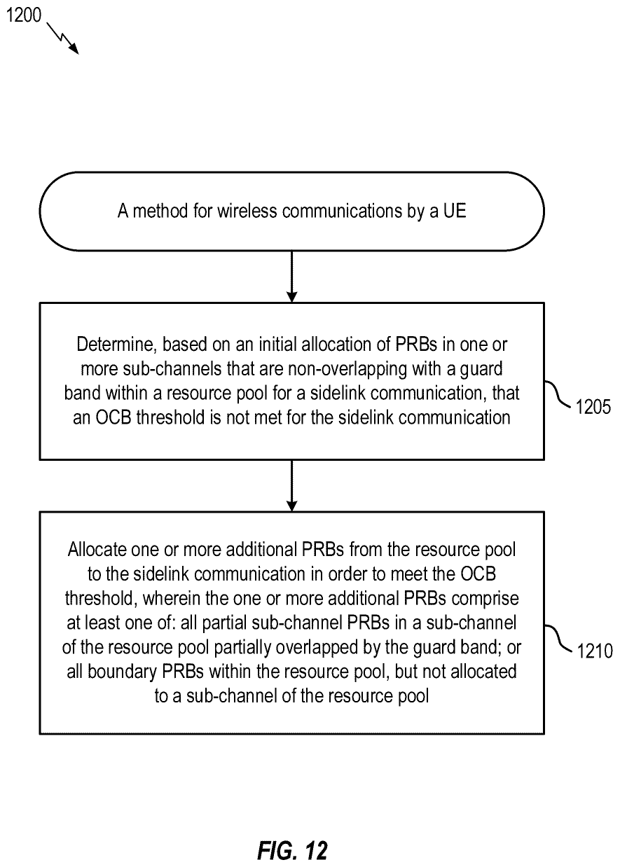

FIG. 12 shows a method 1200 for wireless communications by a UE, such as UE 104 of FIGS. 1 and 3.

Method 1200 begins at step 1205 with determining, based on an initial allocation of PRBs in one or more sub-channels that are non-overlapping with a guard band within a resource pool for a sidelink communication, that an OCB threshold is not met for the sidelink communication.

Method 1200 then proceeds to step 1210 with allocating one or more additional PRBs from the resource pool to the sidelink communication in order to meet the OCB threshold, wherein the one or more additional PRBs comprise at least one of: all partial sub-channel PRBs in a sub-channel of the resource pool partially overlapped by the guard band; or all boundary PRBs within the resource pool, but not allocated to a sub-channel of the resource pool.

In one aspect, in order to allocate the one or more additional PRBs to the sidelink communication, the UE allocates any available boundary PRBs prior to allocating any available partial sub-channel PRBs.

In one aspect, in order to allocate the one or more additional PRBs to the sidelink communication, the UE allocates any available PRB having a higher sub-channel index prior to allocating any available PRB having a lower sub-channel index.

In one aspect, method 1200 further includes associating a boundary PRB within the resource pool to a sub-channel within the resource pool having a highest sub-channel index.

In one aspect, method 1200 further includes associating a boundary PRB within the resource pool to a new sub-channel that comprises a quantity of PRBs fewer than a configured sub-channel size for all other sub-channels in the resource pool.

In one aspect, method 1200 further includes determining a transport block size for the sidelink communication on the initial allocation of PRBs and the one or more additional PRBs based at least in part on a pre-configured nominal sub-channel size.

In one aspect, method 1200 further includes performing rate matching on a given sub-channel allocated to the sidelink communication and overlapping the guard band based on all PRBs in the given sub-channel that overlap the guard band.

In one aspect, method 1200 further includes puncturing the sidelink communication in any PRB overlapping the guard band.

In one aspect, method 1200 further includes determining a transport block size for the sidelink communication on the initial allocation of PRBs and the one or more additional PRBs based at least in part on a reference sub-channel size.

In one aspect, the reference sub-channel size is preconfigured for the resource pool.

In one aspect, a total number of PRBs for a transport block for the sidelink communication is equal to a number of sub-channels allocated to the sidelink communication times a number of PRBs associated with the reference sub-channel size.

In one aspect, method 1200 further includes allocating the partial sub-channel PRBs to the one or more additional PRBs based on a number of partial sub-channel PRBs being greater than a threshold.

In one aspect, method 1200 further includes determining the reference sub-channel size based on a minimum number of PRBs that do not overlap the guard band in sub-channels allocated to the sidelink communication.

In one aspect, method 1200 further includes determining the reference sub-channel size based on a weighted function comprising a first weight associated with sub-channels allocated to the sidelink communication and not overlapping with the guard band and a second weight associated with sub-channels allocated to the sidelink communication and overlapping the guard band.

In one aspect, the weighted function is

$${w}_{1} * {N}_{1} * Subchannel size + {w}_{2} * {\sum }_{i = 1}^{{N}_{2}} {M}_{i} ,$$

w₁ is the first weight, w₂ is the second weight, N₁ is a number of sub-channels allocated to the sidelink communication and not overlapping with the guard band, N₂ is a number of sub-channels allocated to the sidelink communication and overlapping with the guard band, Mᵢ is a number of partial sub-channel PRBs of an i-th sub-channel that overlaps the guard band.

In one aspect, method 1200 further includes rounding an output value of the weighted function to one of a nearest integer value below the output value or a nearest integer value above the output value before determining the reference sub-channel size.

In one aspect, w₁ and w₂ are preconfigured.

In one aspect,

$${w}_{1} = {w}_{2} = \frac{1}{{N}_{1} + {N}_{2}} .$$

In one aspect, method 1200 further includes determining the reference sub-channel size: only for sub-channels allocated to the sidelink communication and overlapping the guard band; and based on one of: a minimum number of partial sub-channel PRBs in sub-channels allocated to the sidelink communication that overlap the guard band; a maximum number of partial sub-channel PRBs in sub-channels allocated to the sidelink communication that overlap the guard band; or an average number of partial sub-channel PRBs in sub-channels allocated to the sidelink communication that overlap the guard band.

In one aspect, method 1200 further includes determining the transport block size based on the reference sub-channel size for sub-channels allocated to the sidelink communication and overlapping the guard band and a pre-configured sub-channel size associated with the resource pool for sub-channels allocated to the sidelink communication and not overlapping the guard band.

In one aspect, a total number of PRBs for a transport block for the sidelink communication is equal to a number of sub-channels allocated to the sidelink communication and overlapping the guard band times a number of PRBs associated with the reference sub-channel size plus a number of sub-channels allocated to the sidelink communication and not overlapping the guard band times a number of PRBs associated with a preconfigured sub-channel size.

In one aspect, method 1200 further includes sending an indication of the reference sub-channel size to a user equipment intended to receive the sidelink communication.

In one aspect, the indication indicates whether a partial sub-channel or a full sub-channel is used as the reference sub-channel size only for sub-channels allocated to the sidelink communication that overlap with the guard band.

In one aspect, a total number of PRBs for a transport block for the sidelink communication is equal to a number of sub-channels allocated to the sidelink communication and overlapping the guard band times a number of PRBs associated with the reference sub-channel size plus a number of sub-channels allocated to the sidelink communication and not overlapping the guard band times a number of PRBs associated with a pre-configured sub-channel size.

In one aspect, the sidelink communication comprises one or both of a PSCCH communication or a PSSCH communication.

In one aspect, method 1200 further includes performing the sidelink communication using the initial allocation of PRBs and the one or more additional PRBs.

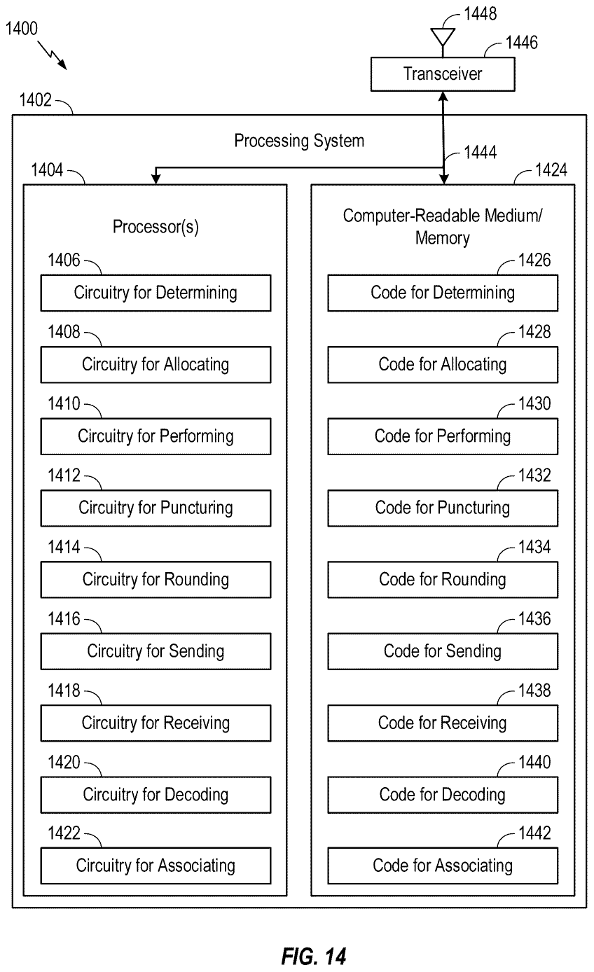

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Generally, where not explicitly indicated as a function of a transmitter UE or receiver UE, the various aspects of method 1200 described above may be performed by either a transmitter UE or receiver UE. For example, a transmitter UE may perform aspects of method 1200 to prepare and send a sidelink communication, and a receiver UE may perform aspects of method 1200 to receive and decode a sidelink communication.

Note that FIG. 12 is just one example of a method, and other methods including fewer, additional, or alternative steps are possible consistent with this disclosure.

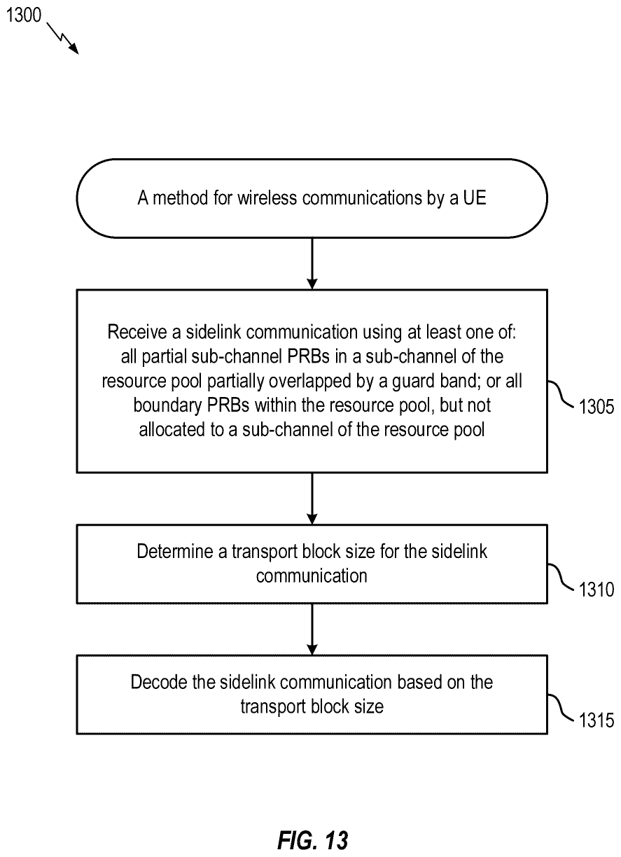

FIG. 13 shows a method 1300 for wireless communications by a UE, such as UE 104 of FIGS. 1 and 3.

Method 1300 begins at step 1305 with receiving a sidelink communication using at least one of: all partial sub-channel PRBs in a sub-channel of the resource pool partially overlapped by a guard band; or all boundary PRBs within the resource pool, but not allocated to a sub-channel of the resource pool.

Method 1300 then proceeds to step 1310 with determining a transport block size for the sidelink communication.

Method 1300 then proceeds to step 1315 with decoding the sidelink communication based on the transport block size.

In one aspect, method 1300 further includes receiving an indication of the reference sub-channel size to a UE intended to receive the sidelink communication.

In one aspect, method 1300 further includes determining a transport block size for the sidelink communication on the initial allocation of PRBs and the one or more additional PRBs based at least in part on a reference sub-channel size.

In one aspect, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative steps are possible consistent with this disclosure.

### Example Communications Device

FIG. 14 depicts aspects of an example communications device 1400. In some aspects, communications device 1400 is a user equipment, such as UE 104 described above with respect to FIGS. 1 and 3.

The communications device 1400 includes a processing system 1402 coupled to a transceiver 1446 (e.g., a transmitter and/or a receiver). The transceiver 1446 is configured to transmit and receive signals for the communications device 1400 via an antenna 1448, such as the various signals as described herein. The processing system 1402 may be configured to perform processing functions for the communications device 1400, including processing signals received and/or to be transmitted by the communications device 1400.

The processing system 1402 includes one or more processors 1404. In various aspects, the one or more processors 1404 may be representative of one or more of receive processor 358, transmit processor 364, TX MIMO processor 366, and/or controller/processor 380, as described with respect to FIG. 3. The one or more processors 1404 are coupled to a computer-readable medium/memory 1424 via a bus 1444. In certain aspects, the computer-readable medium/memory 1424 is configured to store instructions (e.g., computer-executable code) that when executed by the one or more processors 1404 enable and cause the one or more processors 1404 to perform the method 1200 described with respect to FIG. 12, or any aspect related to it, including any additional steps or sub-steps described in relation to FIG. 12; and the method 1300 described with respect to FIG. 13, or any aspect related to it, including any additional steps or sub-steps described in relation to FIG. 13. Note that reference to a processor performing a function of communications device 1400 may include one or more processors performing that function of communications device 1400, such as in a distributed fashion.

In the depicted example, computer-readable medium/memory 1424 stores code for determining 1426, code for allocating 1428, code for performing 1430, code for puncturing 1432, code for rounding 1434, code for sending 1436, code for receiving 1438, code for decoding 1440, and code for associating 1442. Processing of the code 1426-1442 may enable and cause the communications device 1400 to perform the method 1200 described with respect to FIG. 12, or any aspect related to it; and the method 1300 described with respect to FIG. 13, or any aspect related to it.

The one or more processors 1404 include circuitry configured to implement (e.g., execute) the code stored in the computer-readable medium/memory 1424, including circuitry for determining 1406, circuitry for allocating 1408, circuitry for performing 1410, circuitry for puncturing 1412, circuitry for rounding 1414, circuitry for sending 1416, circuitry for receiving 1418, circuitry for decoding 1420, and circuitry for associating 1422. Processing with circuitry for determining 1406-1422 may enable and cause the communications device 1400 to perform the method 1200 described with respect to FIG. 12, or any aspect related to it; and the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1446 and/or antenna 1448 of the communications device 1400 in FIG. 14, and/or one or more processors 1404 of the communications device 1400 in FIG. 14. Means for communicating, receiving or obtaining may include the transceivers 354, antenna(s) 352, receive processor 358, and/or controller/processor 380 of the UE 104 illustrated in FIG. 3, transceiver 1446 and/or antenna 1448 of the communications device 1400 in FIG. 14, and/or one or more processors 1404 of the communications device 1400 in FIG. 14.

### Example Clauses

Implementation examples are described in the following numbered clauses:

Clause 1: A method for wireless communications by a UE comprising: determining, based on an initial allocation of PRBs in one or more sub-channels that are non-overlapping with a guard band within a resource pool for a sidelink communication, that an OCB threshold is not met for the sidelink communication; allocating one or more additional PRBs from the resource pool to the sidelink communication in order to meet the OCB threshold, wherein the one or more additional PRBs comprise at least one of: all partial sub-channel PRBs in a sub-channel of the resource pool partially overlapped by the guard band; or all boundary PRBs within the resource pool, but not allocated to a sub-channel of the resource pool.

Clause 2: The method of Clause 1, wherein in order to allocate the one or more additional PRBs to the sidelink communication, the UE allocates any available boundary PRBs prior to allocating any available partial sub-channel PRBs.

Clause 3: The method of Clause 2, wherein in order to allocate the one or more additional PRBs to the sidelink communication, the UE allocates any available PRB having a higher sub-channel index prior to allocating any available PRB having a lower sub-channel index.

Clause 4: The method of any one of Clauses 1-3, further comprising associating a boundary PRB within the resource pool to a sub-channel within the resource pool having a highest sub-channel index.

Clause 5: The method of any one of Clauses 1-4, further comprising associating a boundary PRB within the resource pool to a new sub-channel that comprises a quantity of PRBs fewer than a configured sub-channel size for all other sub-channels in the resource pool.

Clause 6: The method of any one of Clauses 1-5, further comprising determining a transport block size for the sidelink communication on the initial allocation of PRBs and the one or more additional PRBs based at least in part on a pre-configured nominal sub-channel size.

Clause 7: The method of Clause 6, further comprising performing rate matching on a given sub-channel allocated to the sidelink communication and overlapping the guard band based on all PRBs in the given sub-channel that overlap the guard band.

Clause 8: The method of Clause 6, further comprising puncturing the sidelink communication in any PRB overlapping the guard band.

Clause 9: The method of any one of Clauses 1-8, further comprising: determining a transport block size for the sidelink communication on the initial allocation of PRBs and the one or more additional PRBs based at least in part on a reference sub-channel size.

Clause 10: The method of Clause 9, wherein the reference sub-channel size is preconfigured for the resource pool.

Clause 11: The method of Clause 9, wherein a total number of PRBs for a transport block for the sidelink communication is equal to a number of sub-channels allocated to the sidelink communication times a number of PRBs associated with the reference sub-channel size.

Clause 12: The method of Clause 9, further comprising allocating the partial sub-channel PRBs to the one or more additional PRBs based on a number of partial sub-channel PRBs being greater than a threshold.

Clause 13: The method of Clause 11, further comprising determining the reference sub-channel size based on a minimum number of PRBs that do not overlap the guard band in sub-channels allocated to the sidelink communication.

Clause 14: The method of Clause 11, further comprising determining the reference sub-channel size based on a weighted function comprising a first weight associated with sub-channels allocated to the sidelink communication and not overlapping with the guard band and a second weight associated with sub-channels allocated to the sidelink communication and overlapping the guard band.

Clause 15: The method of Clause 14, wherein: the weighted function is

$${w}_{1} * {N}_{1} * Subchannel size + {w}_{2} * {\sum }_{i = 1}^{{N}_{2}} {M}_{i} ,$$

w₁ is the first weight, w₂ is the second weight, N₁ is a number of sub-channels allocated to the sidelink communication and not overlapping with the guard band, N₂ is a number of sub-channels allocated to the sidelink communication and overlapping with the guard band, Mᵢ is a number of partial sub-channel PRBs of an i-th sub-channel that overlaps the guard band.

Clause 16: The method of Clause 15, further comprising rounding an output value of the weighted function to one of a nearest integer value below the output value or a nearest integer value above the output value before determining the reference sub-channel size.

Clause 17: The method of Clause 15, wherein w₁ and w₂ are preconfigured.

Clause 18: The method of Clause 15, wherein

$${w}_{1} = {w}_{2} = \frac{1}{{N}_{1} + {N}_{2}} .$$

Clause 19: The method of Clause 9, further comprising: determining the reference sub-channel size: only for sub-channels allocated to the sidelink communication and overlapping the guard band; and based on one of: a minimum number of partial sub-channel PRBs in sub-channels allocated to the sidelink communication that overlap the guard band; a maximum number of partial sub-channel PRBs in sub-channels allocated to the sidelink communication that overlap the guard band; or an average number of partial sub-channel PRBs in sub-channels allocated to the sidelink communication that overlap the guard band.

Clause 20: The method of Clause 19, further comprising determining the transport block size based on the reference sub-channel size for sub-channels allocated to the sidelink communication and overlapping the guard band and a pre-configured sub-channel size associated with the resource pool for sub-channels allocated to the sidelink communication and not overlapping the guard band.

Clause 21: The method of Clause 20, wherein a total number of PRBs for a transport block for the sidelink communication is equal to a number of sub-channels allocated to the sidelink communication and overlapping the guard band times a number of PRBs associated with the reference sub-channel size plus a number of sub-channels allocated to the sidelink communication and not overlapping the guard band times a number of PRBs associated with a preconfigured sub-channel size.

Clause 22: The method of Clause 9, further comprising sending an indication of the reference sub-channel size to a user equipment intended to receive the sidelink communication.

Clause 23: The method of Clause 22, wherein the indication indicates whether a partial sub-channel or a full sub-channel is used as the reference sub-channel size only for sub-channels allocated to the sidelink communication that overlap with the guard band.

Clause 24: The method of Clause 22, wherein a total number of PRBs for a transport block for the sidelink communication is equal to a number of sub-channels allocated to the sidelink communication and overlapping the guard band times a number of PRBs associated with the reference sub-channel size plus a number of sub-channels allocated to the sidelink communication and not overlapping the guard band times a number of PRBs associated with a pre-configured sub-channel size.

Clause 25: The method of any one of Clauses 1-24, wherein the sidelink communication comprises one or both of a PSCCH communication or a PSSCH communication.

Clause 26: The method of any one of Clauses 1-25, further comprising performing the sidelink communication using the initial allocation of PRBs and the one or more additional PRBs.

Clause 27: A method for wireless communications by a UE comprising: receiving a sidelink communication using at least one of: all partial sub-channel PRBs in a sub-channel of the resource pool partially overlapped by a guard band; or all boundary PRBs within the resource pool, but not allocated to a sub-channel of the resource pool; determining a transport block size for the sidelink communication; and decoding the sidelink communication based on the transport block size.

Clause 28: The method of Clause 27, further comprising: receiving an indication of the reference sub-channel size to a user equipment intended to receive the sidelink communication; and determining a transport block size for the sidelink communication on the initial allocation of PRBs and the one or more additional PRBs based at least in part on a reference sub-channel size.

Clause 29: One or more apparatuses, comprising: memory comprising executable instructions; and one or more processors configured to execute the executable instructions and cause the one or more apparatuses to perform a method in accordance with any one of Clauses 1-28.

Clause 30: One or more apparatuses, comprising means for performing a method in accordance with any one of Clauses 1-28.

Clause 31: One or more non-transitory computer-readable media comprising executable instructions that, when executed by one or more processors of one or more apparatuses, cause the one or more apparatuses to perform a method in accordance with any one of Clauses 1-28.

Clause 32: One or more computer program products embodied on one or more computer-readable storage media comprising code for performing a method in accordance with any one of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. A user equipment configured for wireless communications, comprising: memory comprising processor-executable instructions; and one or more processors configured to execute the processor-executable instructions and cause the user equipment to:
determine, based on an initial allocation of physical resource blocks (PRBs) in one or more sub-channels that are non-overlapping with a guard band within a resource pool for a sidelink communication, that an occupied channel bandwidth (OCB) threshold is not met for the sidelink communication;
allocate one or more additional PRBs from the resource pool to the sidelink communication in order to meet the OCB threshold,
wherein the one or more additional PRBs comprise at least one of:
all partial sub-channel PRBs in a sub-channel of the resource pool partially overlapped by the guard band; or
all boundary PRBs within the resource pool, but not allocated to a sub-channel of the resource pool.

2. The user equipment of claim 1, wherein in order to allocate the one or more additional PRBs to the sidelink communication, the one or more processors are configured to execute the processor-executable instructions and further cause the user equipment to allocate any available boundary PRBs prior to allocating any available partial sub-channel PRBs.

3. The user equipment of claim 2, wherein in order to allocate the one or more additional PRBs to the sidelink communication, the one or more processors are configured to execute the processor-executable instructions and further cause the user equipment to allocate any available PRB having a higher sub-channel index prior to allocating any available PRB having a lower sub-channel index.

4. The user equipment of claim 1, wherein the one or more processors are further configured to execute the processor-executable instructions and cause the user equipment to associate a boundary PRB within the resource pool to a sub-channel within the resource pool having a highest sub-channel index.

5. The user equipment of claim 1, wherein the one or more processors are further configured to execute the processor-executable instructions and cause the user equipment to associate a boundary PRB within the resource pool to a new sub-channel that comprises a quantity of PRBs fewer than a configured sub-channel size for all other sub-channels in the resource pool.

6. The user equipment of claim 1, wherein the one or more processors are further configured to execute the processor-executable instructions and cause the user equipment to determine a transport block size for the sidelink communication on the initial allocation of PRBs and the one or more additional PRBs based at least in part on a pre-configured nominal sub-channel size.

7. The user equipment of claim 6, wherein the one or more processors are further configured to execute the processor-executable instructions and cause the user equipment to puncture the sidelink communication in any PRB overlapping the guard band, or to perform rate matching on a given sub-channel allocated to the sidelink communication and overlapping the guard band based on all PRBs in the given sub-channel that overlap the guard band.

8. (canceled)

9. The user equipment of claim 1, wherein the one or more processors are further configured to execute the processor-executable instructions and cause the user equipment to determine a transport block size for the sidelink communication on the initial allocation of PRBs and the one or more additional PRBs based at least in part on a reference sub-channel size.

10. The user equipment of claim 9, wherein:
the reference sub-channel size is preconfigured for the resource pool; or
a total number of PRBs for a transport block for the sidelink communication is equal to a number of sub-channels allocated to the sidelink communication times a number of PRBs associated with the reference sub-channel size; or
the one or more processors are further configured to execute the processor-executable instructions and cause the user equipment to allocate the partial sub-channel PRBs to the one or more additional PRBs based on a number partial sub-channel PRBs being greater than a threshold.

11. (canceled)

12. (canceled)

13. The user equipment of claim 10, wherein a total number of PRBs for a transport block for the sidelink communication is equal to a number of sub-channels allocated to the sidelink communication times a number of PRBs associated with the reference sub-channel size, and wherein:
the one or more processors are further configured to execute the processor-executable instructions and cause the user equipment to determine the reference sub-channel size based on a minimum number of PRBs that do not overlap the guard band in sub-channels allocated to the sidelink communication; or
the one or more processors are further configured to execute the processor-executable instructions and cause the user equipment to determine the reference sub-channel size based on a weighted function comprising a first weight associated with sub-channels allocated to the sidelink communication and not overlapping with the guard band and a second weight associated with sub-channels allocated to the sidelink communication and overlapping the guard band.

14. (canceled)

15. The user equipment of claim 14, wherein:
the one or more processors are further configured to execute the processor-executable instructions and cause the user equipment to determine the reference sub-channel size based on a weighted function comprising a first weight associated with sub-channels allocated to the sidelink communication and not overlapping with the guard band and a second weight associated with sub-channels allocated to the sidelink communication and overlapping the guard band; and
the weighted function is
$${w}_{1} * {N}_{1} * Subchannel size + = w 2 * {\sum }_{i = 1}^{N 2} Mi ,$$
wherein
w₁ is the first weight,
w₂ is the second weight,
N₁ is a number of sub-channels allocated to the sidelink communication and not overlapping with the guard band,
N₂ is a number of sub-channels allocated to the sidelink communication and overlapping with the guard band,
Mᵢ is a number of partial sub-channel PRBs of an i-th sub-channel that overlaps the guard band.

16. The user equipment of claim 15, wherein the one or more processors are further configured to execute the processor-executable instructions and cause the user equipment to round an output value of the weighted function to one of a nearest integer value below the output value or a nearest integer value above the output value before determining the reference sub-channel size.

17. The user equipment of claim 15, wherein w₁ and w₂ are preconfigured.

18. The user equipment of claim 15, wherein w₁=w₂=1/(N₁+N₂).

19. The user equipment of claim 9, wherein the one or more processors are further configured to execute the processor-executable instructions and cause the user equipment to determine the reference sub-channel size:
only for sub-channels allocated to the sidelink communication and overlapping the guard band; and
based on one of:
a minimum number of partial sub-channel PRBs in sub-channels allocated to the sidelink communication that overlap the guard band;
a maximum number of partial sub-channel PRBs in sub-channels allocated to the sidelink communication that overlap the guard band; or
an average number of partial sub-channel PRBs in sub-channels allocated to the sidelink communication that overlap the guard band,
wherein:
the one or more processors are further configured to execute the processor-executable instructions and cause the user equipment to determine the transport block size based on the reference sub-channel size for sub-channels allocated to the sidelink communication and overlapping the guard band and a pre-configured sub-channel size associated with the resource pool for sub-channels allocated to the sidelink communication and not overlapping the guard band; or
a total number of PRBs for a transport block for the sidelink communication is equal to a number of sub-channels allocated to the sidelink communication and overlapping the guard band times a number of PRBs associated with the reference sub-channel size plus a number of sub-channels allocated to the sidelink communication and not overlapping the guard band times a number of PRBs associated with a preconfigured sub-channel size.

20. (canceled)

21. (canceled)

22. The user equipment of claim 9, wherein the one or more processors are further configured to execute the processor-executable instructions and cause the user equipment to send an indication of the reference sub-channel size to a user equipment intended to receive the sidelink communication, wherein:
the indication indicates whether a partial sub-channel or a full sub-channel is used as the reference sub-channel size only for sub-channels allocated to the sidelink communication that overlap with the guard band; and
a total number of PRBs for a transport block for the sidelink communication is equal to a number of sub-channels allocated to the sidelink communication and overlapping the guard band times a number of PRBs associated with the reference sub-channel size plus a number of sub-channels allocated to the sidelink communication and not overlapping the guard band times a number of PRBs associated with a pre-configured sub-channel size.

23. (canceled)

24. (canceled)

25. The user equipment of claim 1, wherein the sidelink communication comprises one or both of a physical sidelink control channel (PSCCH) communication or a physical sidelink shared channel (PSSCH) communication.

26. The user equipment of claim 1, wherein the one or more processors are further configured to execute the processor-executable instructions and cause the user equipment to perform the sidelink communication using the initial allocation of PRBs and the one or more additional PRBs.

27. A user equipment configured for wireless communications, comprising: a memory comprising processor-executable instructions; and a processor configured to execute the processor-executable instructions and cause the user equipment to:
receive a sidelink communication using at least one of:
all partial sub-channel PRBs in a sub-channel of the resource pool partially overlapped by a guard band; or
all boundary PRBs within the resource pool, but not allocated to a sub-channel of the resource pool;
determining a transport block size for the sidelink communication; and
decoding the sidelink communication based on the transport block size.

28. (canceled)

29. A method for wireless communications by a user equipment comprising:
determining, based on an initial allocation of PRBs in one or more sub-channels that are non-overlapping with a guard band within a resource pool for a sidelink communication, that an occupied channel bandwidth (OCB) threshold is not met for the sidelink communication; and
allocating one or more additional PRBs from the resource pool to the sidelink communication in order to meet the OCB threshold,
wherein the one or more additional PRBs comprise at least one of:
all partial sub-channel PRBs in a sub-channel of the resource pool partially overlapped by a guard band; or
all boundary PRBs within the resource pool, but not allocated to a sub-channel of the resource pool.

30. (canceled)
